(19) United States
(12) Patent Application Publication
(10) Pub. No.: US 2013/0333141 A1
(43) Pub. Date: Dec. 19, 2013

(54) WINDOW WIPER DEVICE

(71) Applicants: Paul Geubel, Baden-Baden (DE); Mario Huesges, Buehlertal (DE); Orlando Sterns, Budapest (HU)

(72) Inventors: Paul Geubel, Baden-Baden (DE); Mario Huesges, Buehlertal (DE); Orlando Sterns, Budapest (HU)

(73) Assignee: Robert Bosch GmbH, Stuttgart (DE)

(21) Appl. No.: 13/994,701

(22) PCT Filed: Nov. 16, 2011
(86) PCT No.: PCT/EP2011/070192

§ 371 Date: Sep. 3, 2013

(30) Foreign Application Priority Data
Dec. 14, 2010 (DE) 10 2010 063 018.7

(51) Int. Cl. B60S 1/24

(52) U.S. Cl. CPC B60S 1/245
USPC 15/250.29

(57) ABSTRACT

A window wiper device (1), in particular for a rear window wiper of a motor vehicle, with a wiper motor which, via a gear arrangement (3) accommodated in a gear housing (2), drives an output shaft (4), which actuates a wiper lever, wherein, in order to transmit a rotary movement of the wiper motor into an oscillating rotational movement of the output shaft (4), the gear arrangement (3) has a conversion gear (5) which comprises a worm wheel (11), a connecting rod (6) which is connected in a hinged manner to the worm wheel (11), and a toothed segment (8) which is connected in an articulated manner to the connecting rod (6), is mounted rotatably about an axis of rotation in the gear housing (3) in a positionally fixed manner and meshes with a pinion (9) arranged on the output shaft (4), which window wiper device is characterized in that the toothed segment (8) is designed in such a manner that a central tooth axis (Z) formed by the arrangement of the teeth of the toothed segment (8), and the axis of rotation (D) of the toothed segment (8) are offset with respect to each other by a distance (V).

### BACKGROUND OF THE INVENTION

The present invention relates to a window wiper device, in particular for a rear window wiper of a motor vehicle, with a wiper motor which, via a gear arrangement accommodated in a gear housing, drives an output shaft, which actuates a wiper lever, wherein, in order to transfer a rotary movement of the wiper motor into an oscillating rotational movement of the output shaft, the gear arrangement has a conversion gear which comprises a worm wheel, a connecting rod which is connected in a hinged manner to the worm wheel, and a toothed segment which is connected in an articulated manner to the connecting rod, is mounted rotatably about an axis of rotation in the gear housing in a positionally fixed manner and meshes with a pinion arranged on the output shaft.

Window wiper devices of this type are generally known. The prior art describes rear wiper drives, in which an electric motor constantly drives an armature shaft in one direction of rotation. A worm which likewise constantly drives a worm wheel of a spur gear, which is provided in the window wiper device, in one direction of rotation is formed on the armature shaft. Furthermore, the spur gear has a connecting rod and also a toothed segment connected in an articulated manner to the connecting rod via a fastening pin. The toothed segment is mounted rotatably at a distance from the axis of rotation of the output shaft in a positionally fixed manner in the gear housing via a releasable hinge pin and is connected in an articulated manner to the worm wheel via the connecting rod. A toothed segment which meshes with the pinion mounted on the output shaft for conjoint rotation is provided on the web. The axis of rotation of the toothed segment coincides with a tooth axis formed by the teeth of the toothed segment. This leads to play occurring between the toothed segment and the pinion depending in each case on the tolerance position of the individual parts.

It was proposed in the prior art to reduce this play by providing what are referred to as brake teeth in the turning positions. The brake teeth are produced by a jump in the geometry of the toothing. However, it has been shown in the prior art that this embodiment results in an unharmonic wiping behavior because of the jump in the toothing. This leads at the same time to gear noises and to a noisy wiping operation.

It is therefore the object of the present invention to provide a window wiper device which reduces the play in the conversion gear and thereby contributes to a harmonic and quiet wiping behavior of the wiper lever.

### SUMMARY OF THE INVENTION

This object is achieved according to the invention in that the toothed segment is designed in such a manner that a central tooth axis, which is formed by the arrangement of the teeth of the toothed segment, and the axis of rotation of the toothed segment are arranged offset with respect to each other by a distance V.

### ADVANTAGES OF THE INVENTION

In other words, the axis of rotation of the toothed segment is positioned eccentrically with respect to the tooth axis of the toothed segment. A corresponding location bore in the gear housing is provided in the toothed segment and in the gear housing in a manner offset with respect to the central tooth axis formed by the teeth of the toothed segment. By means of this eccentricity, in the turning positions or in the parking position and reversal position of the wiper lever, increased pressure is obtained between the pinion and toothed segment in the turning positions, which results in a reduction in the play in the conversion gear, since an increased pressure prevails in the reversal positions between pinion and toothed segment. As a consequence, the play in the turning positions can be reduced. Also, the position of the wiper lever in the parking position and in the turning positions can be observed. Owing to the associated, substantially more harmonic wiping operation, gear noises can be reduced. The capability of producing the toothing of the toothed segment is also substantially simplified by this means, since graduations no longer have to be provided within the formation of the toothed segment.

Since a different wiping operation is required by the manufacturers for different window wiper devices, depending on the area of use, in particular depending on the type of vehicle, in one exemplary embodiment the distance V between tooth axis and axis of rotation is variably adjustable, and therefore the tooth pressure between pinion and toothed segment is adjustable via the distance V. This can be achieved, for example, by the toothed segment being provided with an elongated hole via which the toothed segment can be fastened in the gear housing, in particular via a fastening screw or a fastening pin in the gear housing.

In order to convey a symmetrical and as sinusoidal as possible a movement sequence of the wiper arm to the windshield of the motor vehicle, provision may be made, in one exemplary embodiment of the present invention, to provide the force flux between the pinion, which is arranged on the output shaft for conjoint rotation, and the toothed segment in one plane, given an appropriate arrangement within the gear housing. As a consequence, transverse forces or moments due to a height offset, which is present in the prior art, between pinion and toothed segment are prevented or are completely eliminated, which leads to lower frictional losses between the force-transmitting components, and therefore to an increase in the efficiency of the window wiper device.

In order to reduce the weight of the gear in the gear housing, a material cut-out can be provided in the toothed segment.

A particularly favorable arrangement of the force-transmitting components in the gear housing makes provision for the pinion and/or the worm wheel and/or the toothed segment, hence all of the force-transmitting elements of the conversion gear with the exception of the connecting rod, to be arranged in a force transmission plane in the gear housing. The effect achieved by this is that moments occurring because of the height graduation present in the prior art can be virtually completely eliminated in the region of the force flux. This leads in turn, as already mentioned, to a reduction in the losses due to friction and therefore to an increase in efficiency.

In order to create a simplified possibility of variation or adjustability of a wiping angle of a window wiper on the windscreen at the motor vehicle type of vehicle, provision is made, in one exemplary embodiment of the present invention, to vary the spacing of the connecting rod from the central axis of the worm wheel by the connecting rod for the articulated connection to the worm wheel engaging by means of a hinge pin in at least one eccentric bore, which is provided in the worm wheel, at a defined distance from the central axis of the worm wheel. A particularly great variation possibility arises if a plurality of eccentric bores are provided on the worm wheel at differing spacing from the central axis thereof.

If the worm wheel has a plurality of eccentric bores which are each arranged at a different spacing from an axis of rotation of the worm wheel, it is furthermore possible, by selection of a corresponding eccentric bore, to change a transmission ratio between toothed segment and pinion and thereby to set different speeds. Alternatively, a plurality of receiving bores can also be provided in the toothed segment in which the connecting rod is fastenable in an articulated manner.

With regard to further advantageous configurations of the invention, reference is made to the explanations of the attached drawings and to the dependent claims.

### BRIEF DESCRIPTION OF THE DRAWINGS

In the drawings:

FIG. 1 shows a perspective illustration of a conversion gear according to the invention in the two turning positions;

FIG. 2 shows an enlarged partial illustration of a conversion gear according to the invention as per FIG. 1 in a turning position;

FIG. 3 shows a toothed segment according to the invention; and

FIG. 4 shows a partial illustration of the toothed segment according to the invention as per FIG. 3.

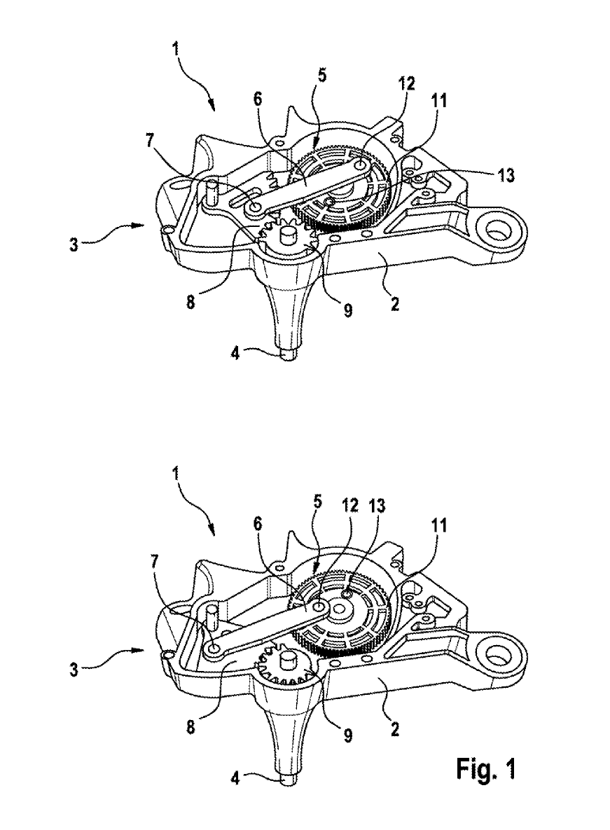

FIG. 1 shows a perspective illustration of a window wiper device 1 for a rear window wiper of a motor vehicle according to the invention.

### DETAILED DESCRIPTION

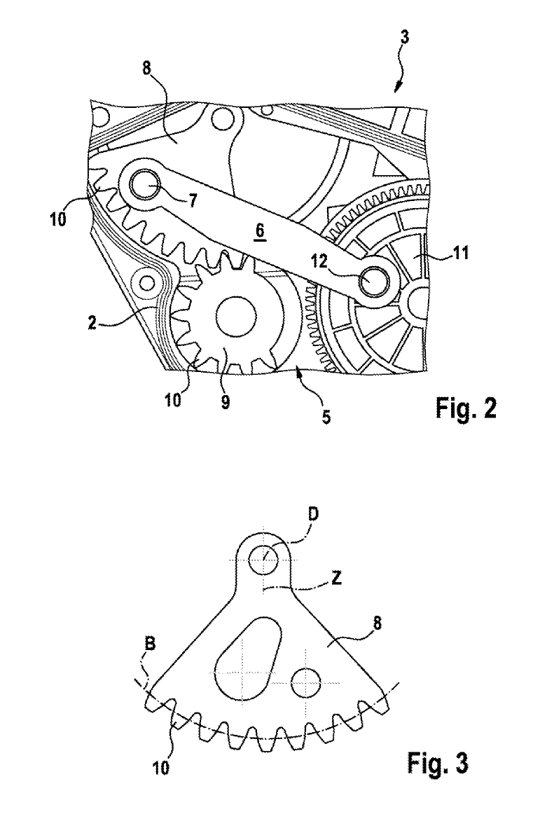

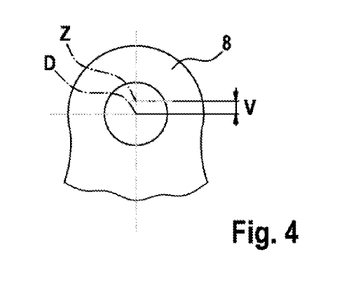

The window wiper device 1 has a wiper motor (not illustrated) which, via a gear arrangement 3 accommodated in a gear housing 2, drives an output shaft 4. Via the output shaft 4, a wiper lever (likewise not illustrated) is movable to and fro on a windshield of the motor vehicle. In order to transfer a rotary movement of the wiper motor into an oscillating rotational movement of the output shaft 4, the gear arrangement 3 has a conversion gear 5. The conversion gear 5, in turn, has a connecting rod 6 and a toothed segment 8 which is connected in an articulated manner to the connecting rod 6 via a fastening pin 7. The toothed segment 8 is mounted rotatably about an axis of rotation D in the gear housing for conjoint rotation via a fastening pin and meshes with a pinion 9 arranged on the output shaft 4. As can be seen in particular in FIGS. 2 and 3, the toothed segment 8 is designed in such a manner that by the arrangement of the teeth 10 of the toothed segment, in particular by means of the center point of the toothing Z, which centerpoint is formed in the tooth circle B, and the axis of rotation D of the toothed segment are arranged offset with respect to each other by a distance V. This leads to the toothings of the toothed segment and of the pinion not being able to become wedged and, nevertheless, increased pressure is achieved in the reversal positions by the bearing bore of the fastening pin 7, which bearing bore is positioned eccentrically with respect to the toothing. The eccentricity leads to increased tooth pressure between the pinion 9 and the toothed segment 8 in the turning positions, as a result of which the play within the conversion gear 5 is reduced. The result is a harmonic wiping operation of the wiper lever on the windshield of the motor vehicle with a simultaneous reduction in the gear noises.

The toothed segment 8, the pinion 9 which meshes with the toothed segment 8 and is connected to the output shaft 4 for conjoint rotation, and a worm wheel 11 which is driven via the connecting rod 6 and moves in a rotary manner are arranged in a common plane in the gear housing 2. The force transmission flux from the wiper motor via an armature shaft, which is provided with a worm, to the worm wheel 11 is therefore undertaken in one force plane via the transmission from the toothed segment 8 to the pinion 9, with the exception of the transmission of the movement from the worm wheel 11 via the connecting rod 6 to the toothed segment 8, and therefore the production of transverse forces can be very substantially suppressed. By means of the positionally fixed mounting of the toothed segment 8 in the gear housing 3, said mounting being arranged eccentrically in the tooth circle B, further protection of the conversion gear 5 from the effect of transverse forces is provided, since transverse forces which may nevertheless occur on the force transmission path can be absorbed by the gear housing 3 via the mounting of the toothed segment 8 by means of the pin 7 and can be conducted away via said gear housing. A more stable sequence of movement is achieved, which is conducive to a symmetrical and as sinusoidal as possible a sequence of movement.

In an alternative exemplary embodiment (not illustrated), provision is made to form an elongated hole in the toothed segment 8 in order to fasten the toothed segment 8 in the gear housing 3. Said elongated hole makes it possible to vary the fastening point, and therefore the rotational point of the toothed segment 8, and therefore also the spacing between the central tooth axis Z, which is formed by the tooth circle B, and the axis of rotation of the toothed segment 8.

1. A window wiper device (1), with a wiper motor which, via a gear arrangement (3) accommodated in a gear housing (2), drives an output shaft (4), which actuates a wiper lever, wherein, in order to transfer a rotary movement of the wiper motor into an oscillating rotational movement of the output shaft (4), the gear arrangement (3) has a conversion gear (5) which comprises a worm wheel (11), a connecting rod (6) which is connected in a hinged manner to the worm wheel (11), and a toothed segment (8) which is connected in an articulated manner to the connecting rod (6), is mounted rotatably about an axis of rotation in the gear housing (3) in a positionally fixed manner and meshes with a pinion (9) arranged on the output shaft (4), characterized in that the toothed segment (8) is designed in such a manner that a central tooth axis (Z), which is formed by the arrangement of the teeth of the toothed segment (8), and the axis of rotation (D) of the toothed segment (8) are arranged offset with respect to each other by a distance V.

2. The window wiper device (1) as claimed in claim 1, characterized in that the distance V is variable and the tooth pressure between pinion (9) and toothed segment (8) is adjustable via the distance V.

3. The window wiper device (1) as claimed in claim 1, characterized in that a material cut-out is provided in the toothed segment to reduce the weight of the gear (5) in the gear housing (3).

4. The window wiper device (1) as claimed in claim 1, characterized in that the pinion (9) and/or the worm wheel (11) and/or the toothed segment (8) are/is arranged in a common plane in the gear housing (3).

5. The window wiper device (1) as claimed in claim 1, characterized in that the connecting rod (6) for the articulated connection to the worm wheel (11) for conjoint rotation engages by means of a hinge pin (17) in at least one eccentric bore provided in the worm wheel (11).

6. The window wiper device (1) as claimed in claim 1, characterized in that the worm wheel (11) and/or the toothed segment (8) have/has a plurality of eccentric bores (12) which are each arranged at a different spacing from an axis of rotation of the toothed segment (8).

7. The window wiper device (1) as claimed in claim 2, characterized in that a material cut-out is provided in the toothed segment to reduce the weight of the gear (5) in the gear housing (3).

8. The window wiper device (1) as claimed in claim 7, characterized in that the pinion (9) and/or the worm wheel (11) and/or the toothed segment (8) are/is arranged in a common plane in the gear housing (3).

9. The window wiper device (1) as claimed in claim 8, characterized in that the connecting rod (6) for the articulated connection to the worm wheel (11) for conjoint rotation engages by means of a hinge pin (17) in at least one eccentric bore provided in the worm wheel (11).

10. The window wiper device (1) as claimed in claim 9, characterized in that the worm wheel (11) and/or the toothed segment (8) have/has a plurality of eccentric bores (12) which are each arranged at a different spacing from an axis of rotation of the toothed segment (8).
